(19) United States
(12) Patent Application Publication
(10) Pub. No.: US 2006/0236448 A1
(43) Pub. Date: Oct. 26, 2006

(54) Multi-hole jet for tub massage systems

(76) Inventors: Dominique Ciechanowski, Sainte-Marguerite-de-Dorchester (CA); Miguel Castellote, Sainte-Marguerite-de-Dorchester (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/406,354

(22) Filed: Apr. 19, 2006

Related U.S. Application Data
(60) Provisional application No. 60/672,873, filed on Apr. 20, 2005.

(51) Int. Cl. A61H 33/04

(52) U.S. Cl. 4/541.6

(57) ABSTRACT

A jet of a tub massage system for injection of a fluid in the liquid of the tub, comprises a tubular body. An inlet end is adapted to be connected to a pressure source. An outlet connection end connects the jet to a tub wall. A unidirectional flow mechanism within the tubular body allow a flow of fluid from the inlet end to the outlet connection end. A cavity is defined in the tubular body at the outlet connection end sized such that at least two holes in the tub wall are in fluid communication with the cavity, whereby fluid from the jet is injected into the tub through the at least two holes. A method for installing the jet to a tub wall is also provided.

### CROSS-REFERENCE TO RELATED APPLICATION

This patent application claims priority on U. S. Provisional Patent Application No. 60/672,873, filed on Apr. 20, 2005, by the present applicant.

### BACKGROUND OF THE INVENTION

1. Field of the Invention

The present invention generally relates to jet systems used in tubs, such as bathtubs, hot tubs, whirlpools and similar basins, and more particularly to a jet for the injection of a fluid into the liquid of such tubs to procure a massaging effect for the occupant of the tub.

2. Background Art

Tubs are well known for their primary use, namely a washroom installation in which a user person washes/bathes. Tubs have, however, evolved to add pleasure and comfort to practicality, and are found in many forms, such as bathtubs, spas and whirlpools. For instance, tubs are now provided with air-jet systems and whirlpool systems.

Air-jet systems of various configurations have been provided to inject a fluid, such as air, into the liquid of the tub, so as to procure a massaging effect for the occupant of the tub. Among the various design factors considered in the creation of air-jet systems, the jets must provide a strong massage sensation to the occupant of the tub, while remaining cost-effective. Moreover, the various washroom furniture often has decorative appeal. Accordingly, jet systems must be discreet in order to blend into the decorative environment of the washroom.

### SUMMARY OF INVENTION

It is a feature of the present invention to provide a novel jet for use in an air-massage system for tubs.

Therefore, in accordance with the present invention, there is provided a jet of a tub massage system for injection of a fluid in the liquid of the tub, comprising: a tubular body; an inlet end adapted to be connected to a pressure source; an outlet connection end for connection of the jet to a tub wall; a unidirectional flow mechanism within the tubular body to allow a flow of fluid from the inlet end to the outlet connection end; and a cavity defined in the tubular body at the outlet connection end sized such that at least two holes in the tub wall are in fluid communication with the cavity; whereby fluid from the jet is injected into the tub through the at least two holes.

Further in accordance with the present invention, there is provided a method for installing a jet of a tub massage system to a tub wall, comprising the steps of: perforating at least two holes in the tub wall, with the at least two holes being within a predetermined surface; providing a jet having an outlet connection end having an opening covering said predetermined surface; positioning the jet with the outlet connection end against the tub wall such that the opening is in register with the at least two holes; and securing the jet to the tub wall.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is an exploded view of a multi-hole jet for tub massage systems in accordance with a preferred embodiment of the present invention;

FIG. 2 is a cross-section view of the multi-hole jet of FIG. 1;

FIG. 3 is a cross-section view of the multi-hole jet of FIG. 1, as mounted to a hidden surface of a tub wall;

FIG. 4 is a perspective view of the multi-hole jet of FIG. 1, as mounted to the tub wall;

FIG. 5 is an elevation view of the multi-hole jet of FIG. 1, as mounted to the tub wall;

FIG. 6 is a plan view of the tub wall having multiple holes as being used with the multi-hole jet of FIG. 1; and

FIG. 7 is an elevation view of the multi-hole jet of FIG. 1, as mounted to the tub wall.

### DESCRIPTION OF THE PREFERRED EMBODIMENTS

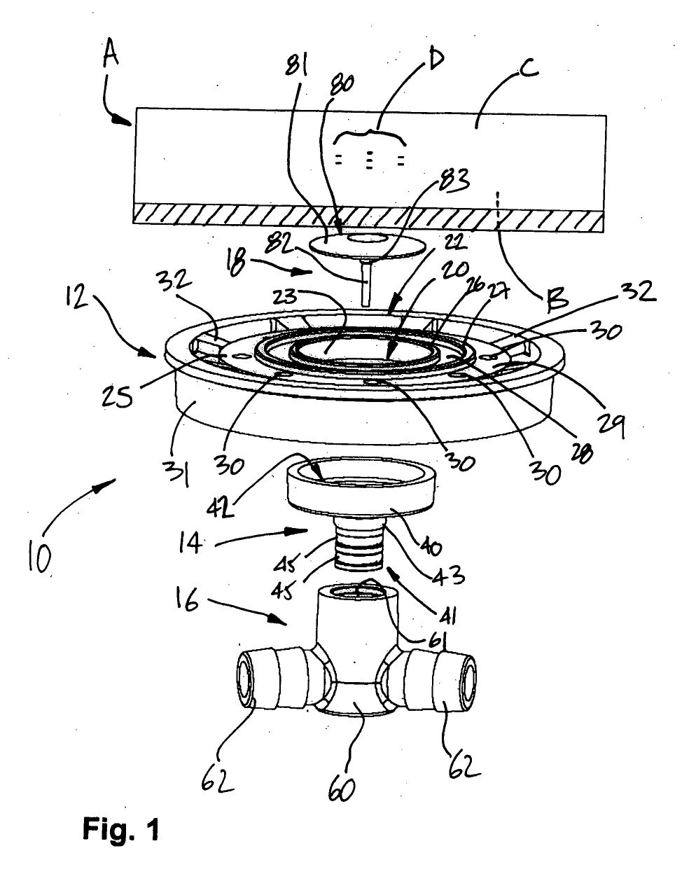

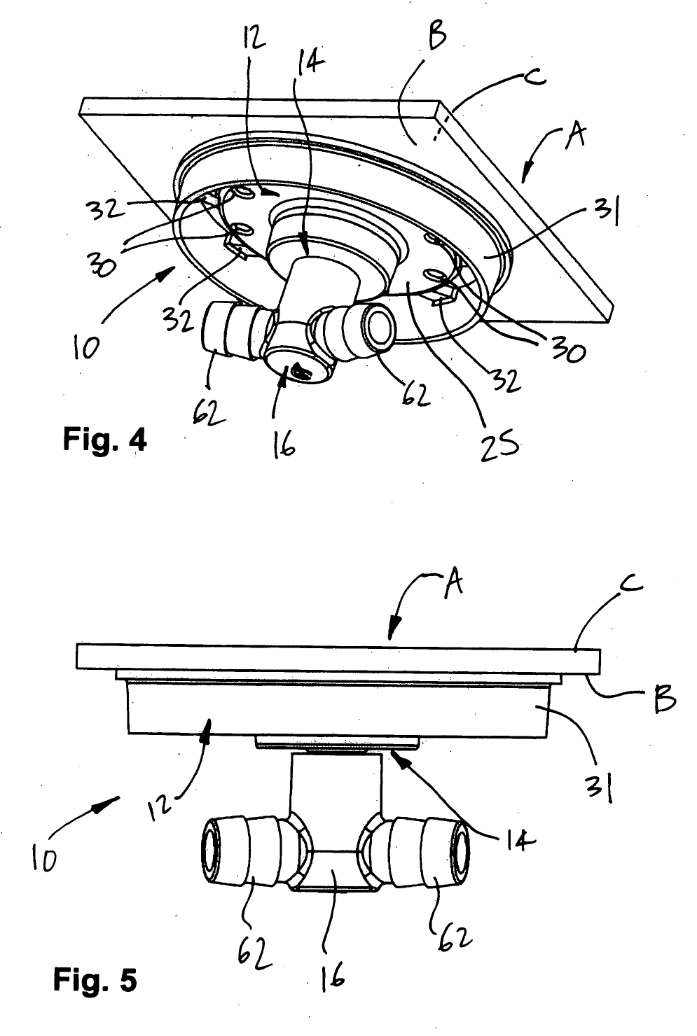

Referring now to the drawings, and more particularly to FIGS. 1 to 5 and 7, a multi-hole jet in accordance with the preferred embodiments is generally shown at 10. For simplicity purposes, the multi-hole jet 10 will mostly be referred to hereinafter as the fluid jet 10.

The fluid jet 10 has a tub connector 12, an interface 14, a fitting 16, and a unidirectional flow mechanism 18. The fluid jet 10 is shown in FIG. 1 with respect to a tub wall A having a hidden surface B and an exposed surface C.

The tub connector 12 is used to connect the fluid jet 10 to the hidden surface B of the tub wall A opposite holes D in the tub wall A for the injection of a fluid (e.g., air) into the liquid (e.g., water) of the tub. The tub connector 12 also houses at least partially the unidirectional flow mechanism 18.

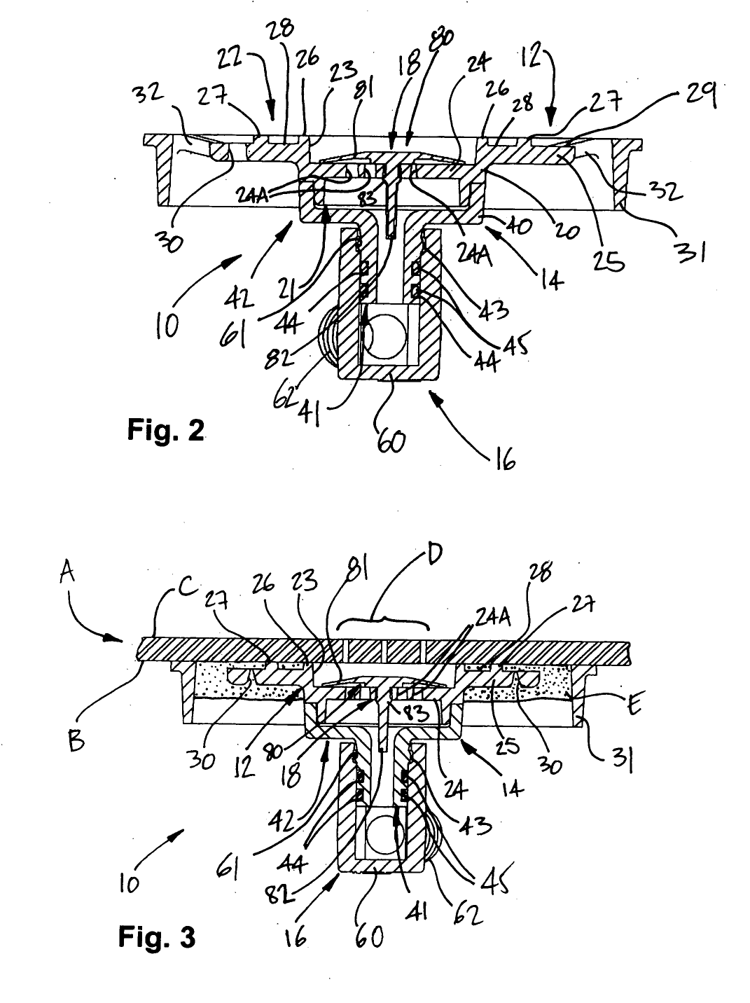

The interface 14 connects the tub connector 12 to the fitting 16. In the embodiment illustrated in FIGS. 1 and 2, the interface 14 is separate from the tub connector 12. However, it is pointed out that the tub connector 12 and the interface 14 may be integrally formed, or that the tub connector 12 may be connected directly to the fitting 16. In the embodiment illustrated in FIGS. 1 and 2, the tub connector 12 is separated from the interface 14 in view of facilitating the manufacture of these components.

The fitting 16 is connected to a pressure source, such as tubing or piping of an air-massage system, by which the fluid jet 10 is supplied with a pressurized fluid for injection into the tub to create a massaging effect on the occupant of the tub.

In order not to impede on the generally smooth exposed surface C of the tub wall A, the fluid jet 10 is preferably fully connected to the hidden surface B of the tub wall A. Considering that a pressure build-up between the fluid jet 10 and the hidden surface B of the tub results from the injection of the fluid into the tub, the connection between the fluid jet 10 and the tub wall A must be able to withstand the forces resulting from the pressure build-up.

Referring concurrently to FIGS. 1, 2 and 3, the tub connector 12 has a tubular body 20 having an inlet connection end 21, by which the tub connector 12 will be connected to the interface 14, and an outlet connection end 22, by which the tub connector 12 will be connected to the tub wall A. A cavity 23 is formed in the tubular body 20 in combination with the hidden surface B, and defines the opening of the fluid jet 10 by which fluid will be injected in the tub.

As seen in FIG. 3, the cavity 23 is positioned opposite holes D in the tub wall A. The cavity 23 may have various geometries, but is illustrated as being circular, preferably with a diameter ranging between 0.5 inch to about 2.0 inches. However, other smaller or greater dimensions and shapes may be appropriate.

The tubular body 20 also has a support 24 to which the unidirectional flow mechanism 18 is connected. Additionally, holes 24A are provided in the support 24, such that fluid may pass therethrough when being injected into the tub through the tubular body 20 of the tub connector 12.

A flange 25 is provided for the connection of the tub connector 12 to the hidden surface B of the tub wall A. The flange 25 has an inner rim 26 and an outer rim 27, which concurrently define an annular channel 28. When the tub connector 12 is connected to the hidden surface B of the tub wall A, it is the inner rim 26 and outer rim 27 that contact the hidden surface B of the tub wall A. Accordingly, a recess 29 is defined between the flange 25 and the hidden surface B. Holes 30 are provided in the flange 25, and facilitate penetration of an adhesive into the recess 29.

A receptacle 31 is provided and is connected to the tubular body 20 of the tub connector 12 by way of arms 32. The receptacle 31 is typically annular, and is concentrically disposed with respect to the tubular body 20.

The interface 14 interrelates the tub connector 12 to the fitting 16. The interface 14 has a tubular body 40 having an inlet connection end 41 and an outlet connection end 42. The interface 14 is connected to the tub connector 12 by way of its outlet connection end 42 being coupled to the inlet connection end 21 of the tub connector 12. More specifically, in the embodiment illustrated in FIGS. l to 3, the outlet connection end 42 is simply fitted over the inlet connection end 21, with an adhesive, such as glue, therebetween. It is pointed out that other ways of connecting the interface 14 to the tub connector 12 are contemplated, such as threading engagement, a quick coupling, or the like.

The inlet connection end 41 of the tub connector 12 is provided with an annular rib 43, which will cooperate with the fitting 16 to secure the fitting 16 to the interface 14. Annular grooves 44 are provided on the peripheral surface of the inlet connection end 41. The annular grooves 44 house annular seals 45, so as to seal off the interconnection between the interface 14 and the fitting 16.

The fitting 16 is illustrated in FIGS. 1 to 5 and 7 as having a tubular body 60. An annular groove 61 is provided within the tubular body 60. The annular groove 61 will cooperate with the rib 43 (FIGS. 2 and 3) of the interface 14 in a quick-coupling relation. Other types of connection between the interface 14 and the fitting 16 are contemplated, such as threading engagement, or the like. Tubing couplings 62 are provided on an opposed end of the tubular body 60, whereby the fitting 16 may be connected to pipes. The tubing couplings 62 are provided with wedge members, such that deformable tubing can be retained thereon in a sealed-off manner.

Although the fitting 16 is illustrated in FIGS. 1 to 5 and 7 as a tee, the fitting 16 may have other configurations, such as an elbow or a nipple.

It is contemplated to use various types of unidirectional flow mechanisms (e.g., check valves with spring-loaded flap or ball, or the like) to prevent infiltration of fluid from the tub in the fluid jet 10 beyond the cavity 23 of the tub connector 12. In the embodiment illustrated in FIGS. 1 to 3, an umbrella-type seal 80 is generally used as the unidirectional flow mechanism 18. More specifically, the umbrella-type seal 80 has a flap end 81, which will be received in the cavity 23 and will resiliently abut against the support 24 in such a way that liquid from the tub will be prevented from penetrating the fitting 16 through the holes 24A. The umbrella-type seal 80 is connected to the support 24 by way of a stem 82. The stem 82 has a bulge 83, by which the umbrella-type seal 80 will remain captive on the support 24.

Upon injection of fluid into the liquid of the tub through the fluid jet 10, a pressure build-up downstream of the umbrella-type seal 80 will cause the flap end 81 to flip towards the hidden surface B of the tub wall A, thereby allowing fluid to pass through the hole 24A of the support 24, into the cavity 23 and into the tub through the holes D. When the injection pressure is released, the flap end 81 will return to the position illustrated in FIGS. 2 and 3, so as to prevent water in the tub from reaching the fitting 16.

In order to connect the tub connector 12 to the hidden surface B of the tub wall A, a liquid adhesive is used, which fills the space between the receptacle 31 and the outer periphery of the tub connector 12. In FIG. 3, the adhesive is generally shown at E. It is pointed out that the fluid jet 10 is often installed on the tub while the tub is still in plant. Accordingly, when the fluid jet 10 is installed on a tub, the tub is often upside down, whereby a liquid adhesive will reach the recess 29 through the holes 30 by way of gravity.

The annular channel 28 is typically used to receive a sealant, such as silicone or latex, so as to increase the sealing connection between the tub connector 12 and the hidden surface B of the tub wall A. More specifically, the sealant is preferably injected into the annular channel 28, and the tub connector 12 is then positioned opposite the holes D in the tub wall A. The liquid adhesive is then poured into the receptacle 31, so as to secure the tub connector 12 to the tub wall A in the manner illustrated in FIG. 3.

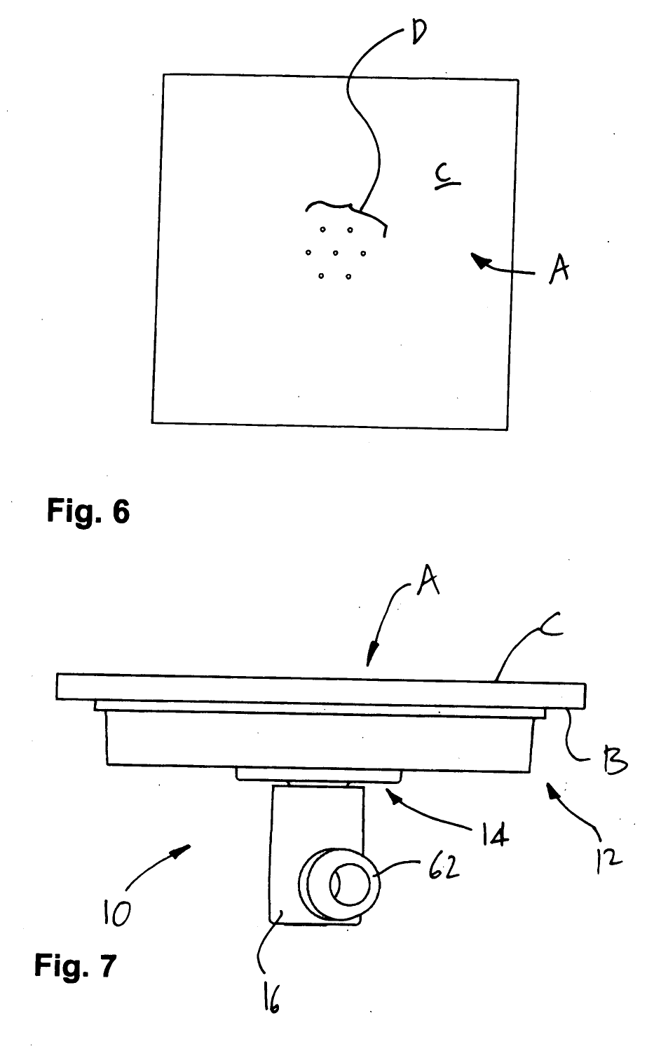

The cavity 23 is sized so as to cover a given area of the hidden surface B of the tub wall A. Accordingly, a plurality of holes D (i.e., at least two holes), as illustrated in FIG. 6, can be fed with injection fluid by a single fluid jet 10. Therefore, fewer jets can be used for an equal amount of holes in the tub wall. Accordingly, a smaller parts-to-holes ratio is attained with the fluid jet 10. In FIG. 6, seven holes D are provided in the shape of a hexagon. It is contemplated to define ornamental patterns with the holes D, so as to embellish the look of the exposed surface C of the tub wall A.

In order to withstand the forces resulting from the pressure build-up, the diameter of the flange 25 is typically 1.5 to 2.5 times larger than the diameter of the cavity 23. Moreover, the inner diameter of the receptacle 31 is typically of at least 1.15 times larger than the outer diameter of the flange 25.

The tub connector 12, the interface 14 and the fitting 16 are typically made of a polymeric material (e.g., injection-molded plastic). However, the use of other materials is contemplated.

1. A jet of a tub massage system for injection of a fluid in the liquid of the tub, comprising:
a tubular body;
an inlet end adapted to be connected to a pressure source;
an outlet connection end for connection of the jet to a tub wall;
a unidirectional flow mechanism within the tubular body to allow a flow of fluid from the inlet end to the outlet connection end; and
a cavity defined in the tubular body at the outlet connection end sized such that at least two holes in the tub wall are in fluid communication with the cavity;
whereby fluid from the jet is injected into the tub through the at least two holes.

2. The jet according to claim 1, wherein the jet is completely connected to a hidden surface of the tub wall, so as not to be visible from an exposed surface of the tub.

3. The jet according to claim 2, wherein the outlet connection end has a flange adhered to the hidden surface of the tub wall.

4. The jet according to claim 3, wherein the flange has rims contacting the hidden surface of the tub wall, so as to define a recess, such that an adhesive is accommodated in the recess to secure the jet to the hidden surface of the tub wall.

5. The jet according to claim 5, wherein the rims concurrently define an annular channel bounded by the flange and the hidden surface of the tub wall so as to accommodate a sealing material.

6. The jet according to claim 4, wherein holes are provided in the flange opposite the recess, so as to facilitate penetration of the adhesive in the recess.

7. The jet according to claim 3, further comprising an annular receptacle secured to the flange, so as to accommodate an adhesive that secures the jet to the hidden surface of the tub wall by encapsulating the flange.

8. The jet according to claim 1, wherein a support member is positioned in the tubular body so as to support the unidirectional flow mechanism.

9. The jet according to claim 8, wherein the support member has holes to allow air to pass therethrough, and wherein the unidirectional flow mechanism is an umbrella-type seal secured to the support member, with a flap end of the umbrella-type seal allowing air to flow out through the holes in the support member, and preventing liquid to flow into the holes in the support member.

10. The jet according to claim 9, wherein the umbrella-type seal has a stem with a bulge, with the flap end and the bulge being on opposed sides of the support member such that the umbrella-type seal is retained by the support member.

11. The jet according to claim 1, further comprising a fitting connected to the inlet end of the tubular body, the fitting being connected to the pressure source by tubing.

12. The jet according to claim 11, wherein the fitting is any one of a tee, a nipple and an elbow.

13. The jet according to claim 11, further comprising an interface between the fitting and the inlet end of the tubular body.

14. The jet according to claim 3, wherein the diameter of the flange is between 1.5 to 2.5 times larger than the diameter of the cavity.

15. The jet according to claim 7, wherein the diameter of the flange is between 1.5 to 2.5 times larger than the diameter of the cavity, and an inner diameter of the receptacle is at least 1.15 times larger than the diameter of the flange.

16. The jet according to claim 1, in combination with a tub, with the at least two holes in the tub wall associated with a single jet represent an ornamental pattern.

17. A method for installing a jet of a tub massage system to a tub wall, comprising the steps of:
perforating at least two holes in the tub wall, with the at least two holes being within a predetermined surface;
providing a jet having an outlet connection end having an opening covering said predetermined surface;
positioning the jet with the outlet connection end against the tub wall such that the opening is in register with the at least two holes; and
securing the jet to the tub wall.

18. The method according to claim 17, wherein the step of perforating the at least two holes involves defining an ornamental pattern with the at least two holes.

19. The method according to claim 17, wherein the step of securing the jet to the tub wall is performed by encapsulating the outlet connection end in an adhesive.
